(19) United States
(12) Patent Application Publication
(10) Pub. No.: US 2005/0254626 A1
(43) Pub. Date: Nov. 17, 2005

(54) Portable holder for X-ray cassettes

(76) Inventor: Weems Hollowell, Homosassa, FL (US)

Correspondence Address: MILES & STOCKBRIDGE PC, 1751 PINNACLE DRIVE, SUITE 500, MCLEAN, VA, 22102-3833, US

(21) Appl. No.: 10/843,583

(22) Filed: May 12, 2004

(51) Int. Cl. G01K 7/00; G03B 42/02

(52) U.S. Cl. 378/177

(57) ABSTRACT

A portable device for taking an X-ray of a human or animal patient comprising: a base for positioning the patient adjacent to an X-ray cassette and an X-ray film cassette holder; the base means comprising a first plate having at least one straight edge, the plate also having an upper side defining an area for receiving the patient to be X-rayed; the X-ray film cassette holder comprising a second plate hingedly attached to the first plate so that the second plate can be positioned between a storage position and a functional position; the second plate defining channels at opposite sides thereof for positioning an X-ray film cassette therein adjacent to the patient to be X-rayed; and, a method for X-raying the patient employing the device.

### BACKGROUND OF THE INVENTION

1. Field of the Invention

This invention relates to a method of x-raying and a device for holding an x-ray film cassette while an x-ray of a part of the body of either a human being or of an animal is being taken.

2. Description of the Prior Art

In the practice of emergency medicine it is frequently necessary to produce an x-ray image of a part of a human or animal patient that has been seriously injured and cannot move or be moved to the appropriate position relative to the source of X-rays. Usually, the x-ray film is in a cassette and it is extremely difficult, if not impossible to position the part of the body of the patient that is to be x-rayed between the source of the x-rays and the cassette that holds the film.

Moreover, some types of medical conditions render it virtually impossible to move patients once they have assumed the desired position in bed, either due to the fact that they have serious injuries, they are unconscious, or because they would experience severe pain if they were moved. For example, patients with certain types of arthritis experience severe pain when they are placed on an unyielding surface such as a typical X-ray table, or when they are required to move even slightly. In these circumstances, medical imaging procedures must be performed while the patient remains in bed.

Thus, there exists the need for a portable medical imaging film cassette holder that will enable the positioning of the film relative to the medical imaging apparatus and the patient to be imaged that does not require substantial movement or physical repositioning of the patient. Currently available systems such as those marketed by AliMed, Inc. of Dedham, Mass. do not provide satisfactory results in this regard.

It is an object of the present invention to provide such a portable imaging film cassette holder device.

It is a further object of the invention to provide a novel method of medical imaging employing the device of the invention.

### SUMMARY OF THE INVENTION

The above and other objects are realized by the present invention, one embodiment of which relates to a portable device for taking an X-ray of a human or animal patient comprising:

a base means for positioning a portion of the patient adjacent to an X-ray cassette and an X-ray film cassette holder means;

the base means comprising a first plate member having at least one substantially straight edge, the plate also having an upper side defining an area for receiving a part of a patient to be X-rayed;

the X-ray film cassette holder means comprising a second plate member hingedly attached to the first plate at the substantially straight edge so that the second plate can be selectively raised and lowered between a storage position wherein the second plate lies substantially parallel to the upper side of the first plate and a functional position wherein the second plate is substantially vertical to the upper surface of the first plate;

the second plate defining C-shaped channels at opposite sides thereof for positioning an X-ray film cassette therein adjacent to the portion of the patient to be X-rayed when the second plate is raised to the functional position, the channels extending substantially vertical to the straight edge of the first plate.

Another embodiment of the invention concerns a method of positioning a patient and an X-ray film cassette relative to each other for the purpose of X-raying the patient comprising:

providing the device of claim 1 so that the second plate is raised to the functional position;

inserting an X-ray film cassette in the C-shaped channels;

positioning the patient on the area of the upper side so that X-rays passing in a given path through the patient will intersect the cassette, and

transmitting X-rays along the path.

### BRIEF DESCRIPTION OF THE DRAWINGS

FIG. 1 is a top perspective view of the invention in its functional position.

FIG. 2 is a top perspective of the device of the invention in its storage or closed position

### DETAILED DESCRIPTION OF THE INVENTION

Other objects, features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

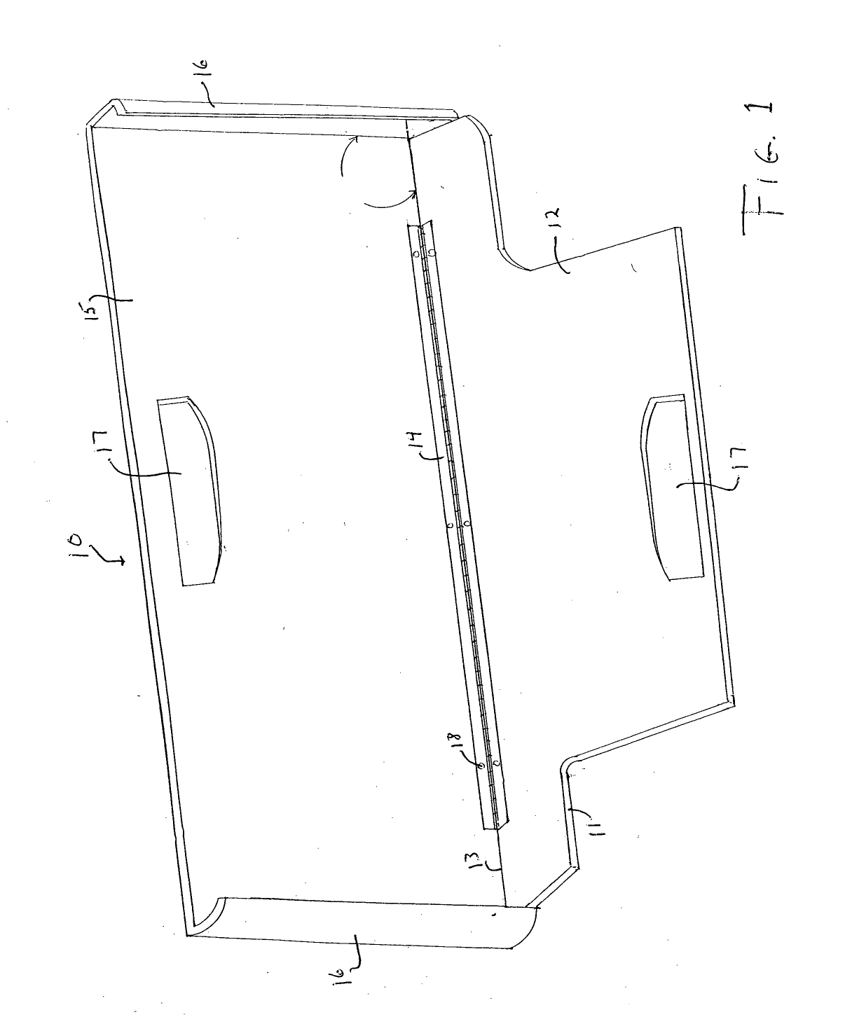

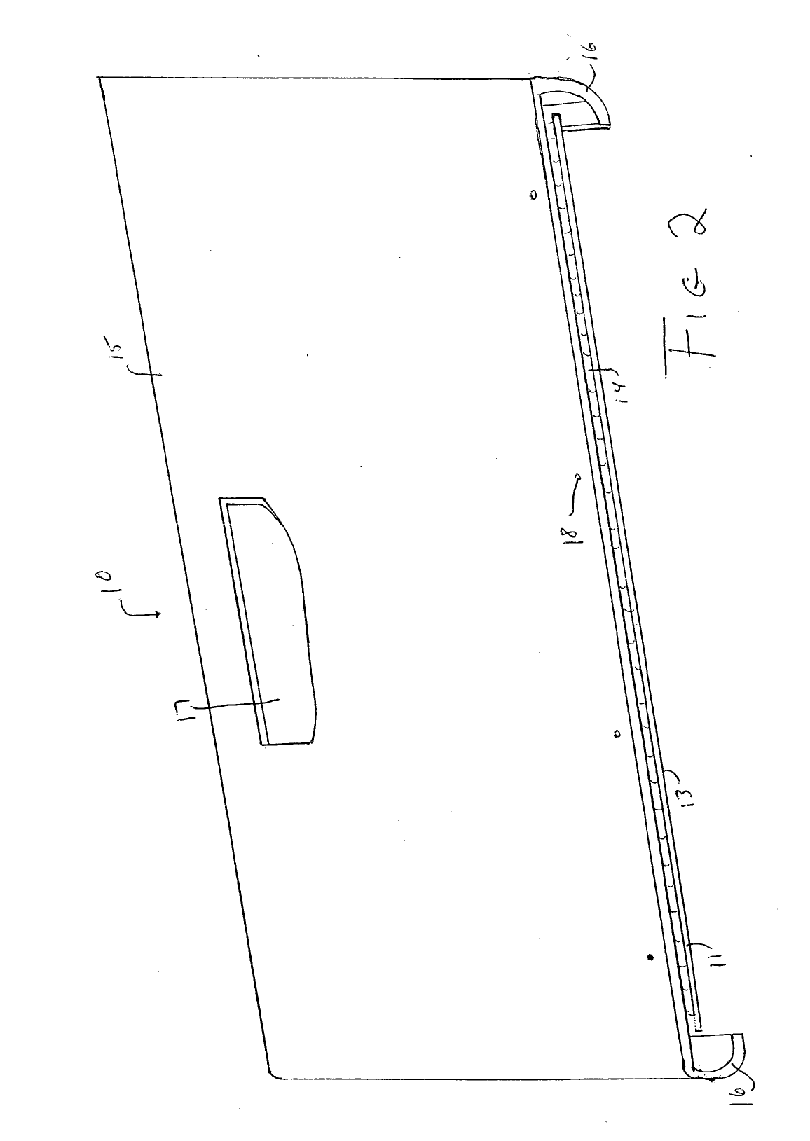

An illustrative embodiment of the medical imaging film cassette holder and method of the present invention will be described with reference to following drawings in which like numerals refer to like elements, and in which FIG. 1 depicts a medical imaging film cassette holder 10 comprised of a base plate 11, having one side defining a straight edge 13 and an upper surface 12 having an area sufficient to anchor holder 10 between a patient (not shown) and a surface (not shown) supporting the patient. Hingedly attached to the upper surface 12 of base plate 11 by hinge means 14 at the straight edge 13 is holder plate 15. The hinged attachment allows the holder plate 15 to be selectively raised and lowered between a storage position (shown in FIG. 2) wherein the holder plate lies substantially parallel to the upper surface 12 of base plate 11 and a functional position (shown in FIG. 1) wherein said holder plate 15 is substantially vertical to the upper surface 12 of base plate 11. Hinge means 14 is attached to base plate 11 and holder plate 15 by suitable attaching means (rivets, screws and the like) 18.

The holder plate 15 also defines C-shaped channels 16 at opposite sides thereof in which a medical imaging film cassette (not shown) can be positioned adjacent to the portion of the patient positioned on the upper surface 12 of base plate 11 when the holder plate 15 is in the functional position. The C-shaped channels 16 are constructed so as to extend substantially vertical to the straight edge 13 of base plate 11 when holder plate 15 is hingedly attached thereto. The C-shaped channels 16 may extend on the side of the holder plate 15 that lies parallel to upper surface 12 of base plate 11 when holder plate 15 is lowered to the storage position, or they may extend on the side opposite to the side of the holder plate 15 that lies parallel to upper surface 12 of base plate 11 when holder plate 15 is lowered to the storage position.

Preferably, the holder plate 15 is hingedly attached to base plate 12 so that, when raised to the functional position, is prevented by the straight edge from extending to a position such that the interior angle A formed between the two plates is more than about 90°. The holder plate may be hingedly attached to base plate along substantially the entire length of straight edge 13 or along substantially less than the entire length of straight edge 13 as shown in FIG. 1.

The plates 12 and 15 may optionally be provided with openings 17 therethrough to facilitate portability or carrying the holder 10 and raising and lowering the plates between storage and functional positions. Preferably, the openings are appropriately hand-sized and are substantially coextensive when the holder is in the closed or storage position.

A further illustrative embodiment of the invention is shown in FIG. 2 wherein holder 10 is depicted in its closed or storage position.

It will be understood that the holder 10 may be constructed of any material suitable for a medical imaging environment. Preferably, the plates 11 and 15 are constructed of any medically acceptable rigid or semirigid material such as a plastic, e.g., PVC, ABS and the like. The dimensions of the holder 10 and its principal components, base plate 11, holder plate 15, C-shaped channels 16 and hinge means 14 are not overly critical, will depend upon the intended use and application of the device and are well within the purview of one skilled in the art without resort to undue experimentation. The thickness of the base plate 11 should be sufficiently thin to allow sliding or otherwise positioning between a patient to be imaged and the surface supporting the patient, yet sufficiently thick so as to form a flange surface that prevents extension of the upper plate 15 to a position such that the interior angle A formed between the two plates at straight edge 13 is more than about 90°. The holder plate should be of dimensions that will allow imaging of any desired portion of the patient's body.

Thus, it can be seen that the portable film cassette holder 10 of the present invention provides for convenient placement of a film cassette adjacent a patient for imaging of a desired portion of the patient's anatomy.

The invention also provides a method of positioning a human or animal patient and a medical imaging film cassette relative to each other for the purpose of imaging the patient. Employing the device depicted in the drawings, the holder plate 15 is raised to the functional position shown in FIG. 1, an X-ray film cassette, for example, is inserted in the C-shaped channels 16, the base plate 11 is slid under a patient lying, for example on a bed, such that the portion of the patient desired to be imaged is adjacent the cassette and such that X-rays passing in a given path through the patient will intersect the cassette, and X-rays are transmitted along the path. Following completion of the imaging procedure, the base plate is simply slid from beneath the patient and the device collapsed to the closed or storage position shown in FIG. 2.

It will be understood by those skilled in the art that the medical imaging film cassette holder device of the invention may take any desired shape, depending upon its intended function. It will also be understood by those skilled in the art that, although the device disclosed herein has been illustrated as being utilized for X-ray imaging, it may also be used in connection with any type of medical imaging requiring the use of a film cassette.

1. A portable device for taking an X-ray of a human or animal patient comprising:
a base means for positioning a portion of the patient adjacent to an X-ray cassette and an X-ray film cassette holder means;
said base means comprising a first plate member having at least one substantially straight edge, said plate also having an upper side defining an area for receiving a part of a patient to be X-rayed;
said X-ray film cassette holder means comprising a second plate member hingedly attached to said first plate at said substantially straight edge so that said second plate can be selectively positioned between a storage position wherein said second plate lies substantially parallel to said upper side of said first plate and a functional position wherein said second plate is substantially vertical to said upper surface of said first plate;
said second plate defining C-shaped channels at opposite sides thereof for positioning an X-ray film cassette therein adjacent to said portion of said patient to be X-rayed when said second plate is in said functional position, said channels extending substantially vertical to said straight edge of said first plate.

2. The device of claim 1 wherein said C-shaped channels extend on the side of the second plate that lies parallel to said first plate when said second plate is in said storage position.

3. The device of claim 1 wherein said C-shaped channels extend on the side opposite to the side of the second plate that lies parallel to said first plate when said second plate is in said storage position.

4. The device of claim 1 wherein said second plate, when in said functional position, is prevented by said straight edge from extending to a position such that the interior angle formed between said first and second plates is more than about 90°.

5. The device of claim 1 wherein said first and second plates are provided with substantially coextensive openings therethrough to facilitate carrying said device and placing said second plate in said storage and functional positions.

6. The device of claim 5 wherein said substantially coextensive openings are approximately human hand sized.

7. The device of claim 1 wherein said second plate is substantially rectangular in shape.

8. The device of claim 1 wherein said second plate is hingedly attached to said first plate along substantially the entire length of said straight edge.

9. The device of claim 1 wherein said second plate is hingedly attached to said first plate along substantially less than the entire length of said straight edge.

10. The device of claim 1 wherein the area of said upper surface of said first plate is sufficient to anchor said device between said patient and a surface supporting said patient.

11. The device of claim 1 wherein said first and second plates are constructed of a medically acceptable rigid or semirigid material such as a plastic.

12. The device of claim 11 wherein said plastic is PVC, ABS or the like.

13. An article of manufacture comprising packaging material and a portable device for positioning a part of a patient adjacent to an X-ray film cassette for taking an X-ray contained within said packaging material, wherein said device is effective for enabling the X-raying of patients, and wherein said packaging material comprises a label which indicates that said device is so useful, and wherein said device comprises that of claim 1.

14. A method of positioning a patient and an X-ray film cassette relative to each other for the purpose of X-raying said patient comprising:
providing said device of claim 1 so that said second plate is in said functional position;
inserting an X-ray film cassette in said C-shaped channels;
positioning said patient on said area of said upper side so that X-rays passing in a given path through said patient will intersect said cassette, and
transmitting X-rays along said path.

15. The method of claim 14 wherein said area of said upper side is sufficient to anchor said device between said patient and a surface supporting said patient.

16. The method of claim 15 wherein said surface supporting said patient is a bed.

17. The method of claim 15 wherein said surface supporting said patient is an operating table.
